(19) United States
(12) Patent Application Publication
(10) Pub. No.: US 2022/0021668 A1
(43) Pub. Date: Jan. 20, 2022

(54) USER AUTHENTICATION BASED ON CONFIDENCE LEVELS FOR IDENTITY PREDICTIONS

(71) Applicant: Facebook, Inc., Menlo Park, CA (US)

(72) Inventors: Nikhil Gautam, Santa Clara, CA (US); Eric W. Hwang, San Jose, CA (US); Arup Kanjilal, San Jose, CA (US)

(21) Appl. No.: 16/933,953

(22) Filed: Jul. 20, 2020

(51) Int. Cl. H04L 29/06; G06F 21/62

(52) U.S. Cl. CPC H04L 63/0861; G06F 21/629; G06K 9/00087; H04L 63/107; H04L 63/102

(57) ABSTRACT

A computing device determines availability of device features based on confidence levels associated with predicted identities of an individual within a recognition range of the device. The computing device determines the one or more confidence levels based on captured recognition information including biometric data describing the individual. The computing device determines whether a given action associated with a device feature is available to an individual based on whether the confidence level satisfies authorization criteria corresponding to the action.

### BACKGROUND

Devices such as in-home smart assistants, phone systems, or video conferencing systems are often used by multiple different individuals. These shared devices may host and display content relating to individual user preferences, interests, friends, and other provided personal data. Furthermore, these shared devices may provide features which are restricted to authenticated individuals (e.g., users who are logged in to a particular profile). However, a challenge exists in enabling different users to take advantage of personalized features, or to access restricted features, in an intelligent way.

### SUMMARY

This disclosure relates generally to interactions with a computing device shared by several individuals, and more particularly to making device features available based on confidence levels associated with predicted identities for individuals. The computing device determines one or more confidence levels based on received recognition information including biometric data describing an individual (e.g., facial recognition data, voice recognition data, finger print data, etc.). The computing device determines whether a given action associated with a device feature is available to an individual based on whether the confidence level satisfies authorization criteria corresponding to the action.

The computing device associates authentication criteria with respective actions of the computing device. In particular, the authentication criteria for each respective action includes a confidence threshold from a plurality of confidence thresholds for the computing device. The computing device receives an interaction from an individual within a recognition range of the computing device. The computing device captures recognition information including biometric data describing the individual. Based at least in part on the recognition information, the computing device calculates a confidence level associated with a predicted identity of the individual. The computing device identifies an action of the computing device based on the interaction. The computing device determines that the authentication criteria associated with the action are satisfied based at least in part on the confidence level exceeding the confidence threshold. In response to determining the authentication criteria associated with the action are satisfied, the computing device performs the action.

In some embodiments, the recognition information used to determine the confidence level includes contextual information describing activity of one or more individuals, such as previously determined confidence levels or previous interactions by individuals with the computing device.

### BRIEF DESCRIPTION OF THE DRAWINGS

FIG. 1 is a block diagram of a system environment for a communication system, in accordance with an embodiment.

FIG. 2 is a block diagram of an example architecture for a user management module, in accordance with an embodiment.

FIG. 3 is a flow diagram of a method for performing an action based on a confidence level associated with a predicted identity of an individual, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

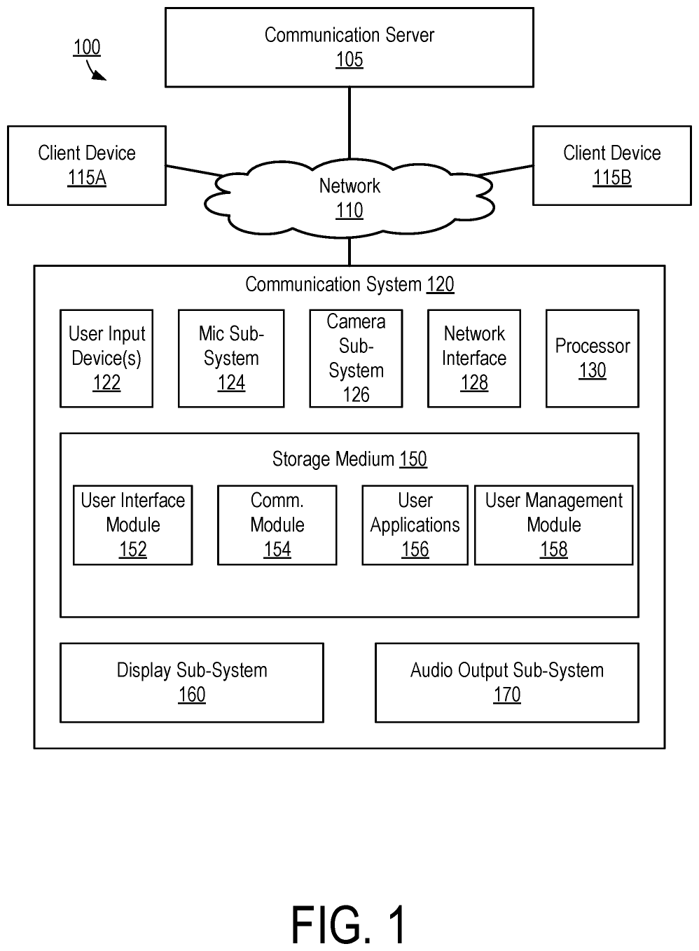

FIG. 1 is a block diagram of a system environment 100 for a communication system 120. The system environment 100 includes a communication server 105, one or more client devices 115 (e.g., client devices 115A, 115B), a network 110, and a communication system 120. In alternative configurations, different and/or additional components may be included in the system environment 100. For example, the system environment 100 may include additional client devices 115, additional communication servers 105, or additional communication systems 120.

In an embodiment, the communication system 120 comprises an integrated computing device that operates as a standalone network-enabled device. In another embodiment, the communication system 120 comprises a computing device for coupling to an external media device such as a television or other external display and/or audio output system. In this embodiment, the communication system may couple to the external media device via a wireless interface or wired interface (e.g., an HDMI cable) and may utilize various functions of the external media device such as its display, speakers, and input devices. Here, the communication system 120 may be configured to be compatible with a generic external media device that does not have specialized software, firmware, or hardware specifically for interacting with the communication system 120.

The client devices 115 are one or more computing devices capable of receiving user input as well as transmitting and/or receiving data via the network 110. In one embodiment, a client device 115 is a conventional computer system, such as a desktop or a laptop computer. Alternatively, a client device 115 may be a device having computer functionality, such as a personal digital assistant (PDA), a mobile telephone, a smartphone, a tablet, an Internet of Things (IoT) device, a video conferencing device, another instance of the communication system 120, or another suitable device. A client device 115 is configured to communicate via the network 110. In one embodiment, a client device 115 executes an application allowing a user of the client device 115 to interact with the communication system 120 by enabling voice calls, video calls, data sharing, or other interactions. For example, a client device 115 executes a browser application to enable interactions between the client device 115 and the communication system 120 via the network 110. In another embodiment, a client device 115 interacts with the communication system 120 through an application running on a native operating system of the client device 115, such as IOS® or ANDROID™.

The communication server 105 facilitates communications of the client devices 115 and the communication system 120 over the network 110. For example, the communication server 105 may facilitate connections between the communication system 120 and a client device 115 when a voice or video call is requested. Additionally, the communication server 105 may control access of the communication system 120 to various external applications or services available over the network 110. In an embodiment, the communication server 105 may provide updates to the communication system 120 when new versions of software or firmware become available. In other embodiments, various functions described below as being attributed to the communication system 120 can instead be performed entirely or in part on the communication server 105. For example, in some embodiments, various processing or storage tasks may be offloaded from the communication system 120 and instead performed on the communication server 105.

The network 110 may comprise any combination of local area and/or wide area networks, using wired and/or wireless communication systems. In one embodiment, the network 110 uses standard communications technologies and/or protocols. For example, the network 110 includes communication links using technologies such as Ethernet, 802.11 (WiFi), worldwide interoperability for microwave access (WiMAX), 3G, 4G, 5G, code division multiple access (CDMA), digital subscriber line (DSL), Bluetooth, Near Field Communication (NFC), Universal Serial Bus (USB), or any combination of protocols. In some embodiments, all or some of the communication links of the network 110 may be encrypted using any suitable technique or techniques.

The communication system 120 includes one or more user input devices 122, a microphone sub-system 124, a camera sub-system 126, a network interface 128, a processor 130, a storage medium 150, a display sub-system 160, and an audio sub-system 170. In other embodiments, the communication system 120 may include additional, fewer, or different components.

The user input device 122 comprises hardware that enables a user to interact with the communication system 120. The user input device 122 can comprise, for example, a touchscreen interface, a game controller, a keyboard, a mouse, a joystick, a voice command controller, a gesture recognition controller, a remote control receiver, or other input device. In an embodiment, the user input device 122 may include a remote control device that is physically separate from the user input device 122 and interacts with a remote controller receiver (e.g., an infrared (IR) or other wireless receiver) that may integrated with or otherwise connected to the communication system 120. The remote control device and/or the user input device 122 may include one or more sensors for receiving biometric data input from a user, such as a finger print scanner, palm print scanner, iris and/or retina imaging device, electronic nose, or any other sensor capable of collecting biometric data describing identifying characteristics of an individual. Additionally, a user of the communication system 120 may optionally disable and/or opt out of biometric data collection by the remote control device. In some embodiments, the display sub-system 160 and the user input device 122 are integrated together, such as in a touchscreen interface. In other embodiments, user inputs may be received over the network 110 from a client device 115. For example, an application executing on a client device 115 may send commands over the network 110 to control the communication system 120 based on user interactions with the client device 115. As another example, a client device 115 may collect biometric data from a user operating the client device 115 and transmit the biometric data to the communication system 120. In other embodiments, the user input device 122 may include a port (e.g., an HDMI port) connected to an external television that enables user inputs to be received from the television responsive to user interactions with an input device of the television. For example, the television may send user input commands to the communication system 120 via a Consumer Electronics Control (CEC) protocol based on user inputs received by the television.

The microphone sub-system 124 comprises one or more microphones (or connections to external microphones) that capture ambient audio signals by converting sound into electrical signals that can be stored or processed by other components of the communication system 120. The captured audio signals may be transmitted to the client devices 115 during an audio/video call or in an audio/video message. Additionally, the captured audio signals may be processed to identify voice commands for controlling functions of the communication system 120. The captured audio signals may further be used to perform voice recognition, e.g., predicting an identity of an individual whose voice produced the audio signals. In an embodiment, the microphone sub-system 124 comprises one or more integrated microphones. Alternatively, the microphone sub-system 124 may comprise an external microphone coupled to the communication system 120 via a communication link (e.g., the network 110 or other direct communication link). The microphone sub-system 124 may comprise a single microphone or an array of microphones. In the case of a microphone array, the microphone sub-system 124 may process audio signals from multiple microphones to generate one or more beamformed audio channels each associated with a particular direction (or range of directions). A user of the communication system 120 may optionally disable and/or opt out of any of the processes performed by the camera sub-system 126.

The camera sub-system 126 comprises one or more cameras (or connections to one or more external cameras) that captures images and/or video signals. The captured images or video may be sent to the client device 115 during a video call or in a multimedia message, or may be stored or processed by other components of the communication system 120. Furthermore, in an embodiment, the camera sub-system 126 or another component of communication system 120 processes images or video captured by the camera sub-system 126 to detect individual humans in the environment around the communication system 120. Additionally, images or video from the camera sub-system 126 may be processed for face detection, face recognition, gesture recognition, or other information that may be utilized to control functions of the communication system 120. In an embodiment, the camera sub-system 126 includes one or more wide-angle cameras for capturing a wide, panoramic, or spherical field of view of a surrounding environment. The camera sub-system 126 may include integrated processing to stitch together images from multiple cameras, or to perform image processing functions such as zooming, panning, de-warping, or other functions. In an embodiment, the camera sub-system 126 may include multiple cameras positioned to capture stereoscopic (e.g., three-dimensional images) or may include a depth camera to capture depth values for pixels in the captured images or video. A user of the communication system 120 may optionally disable and/or opt out of any of the processes performed by the camera sub-system 126.

The network interface 128 facilitates connection of the communication system 120 to the network 110. For example, the network interface 128 may include software and/or hardware that facilitates communication of voice, video, and/or other data signals with one or more client devices 115 to enable voice and video calls or other operation of various applications executing on the communication system 120. The network interface 128 may operate according to any conventional wired or wireless communication protocols that enable it to communicate over the network 110.

The display sub-system 160 comprises an electronic device or an interface to an electronic device for presenting images or video content. For example, the display sub-system 160 may comprises an LED display panel, an LCD display panel, a projector, a virtual reality headset, an augmented reality headset, another type of display device, or an interface for connecting to any of the above-described display devices. In an embodiment, the display sub-system 160 includes a display that is integrated with other components of the communication system 120. Alternatively, the display sub-system 160 comprises one or more ports (e.g., an HDMI port) that couples the communication system to an external display device (e.g., a television).

The audio output sub-system 170 comprises one or more speakers or an interface for coupling to one or more external speakers that generate ambient audio based on received audio signals. In an embodiment, the audio output sub-system 170 includes one or more speakers integrated with other components of the communication system 120. Alternatively, the audio output sub-system 170 comprises an interface (e.g., an HDMI interface or optical interface) for coupling the communication system 120 with one or more external speakers (for example, a dedicated speaker system or television). The audio output sub-system 170 may output audio in multiple channels to generate beamformed audio signals that give the listener a sense of directionality associated with the audio. For example, the audio output sub-system 170 may generate audio output as a stereo audio output or a multi-channel audio output such as 2.1, 3.1, 5.1, 7.1, or other standard configuration.

In embodiments in which the communication system 120 is coupled to an external media device such as a television, the communication system 120 may lack an integrated display and/or an integrated speaker, and may instead only communicate audio/visual data for outputting via a display and speaker system of the external media device.

The processor 130 operates in conjunction with the storage medium 150 (e.g., a non-transitory computer-readable storage medium) to carry out various functions attributed to the communication system 120 described herein. For example, the storage medium 150 may store one or more modules or applications (e.g., user interface module 152, communication module 154, user applications 156, user management module 158) embodied as instructions executable by the processor 130. The instructions, when executed by the processor, cause the processor 130 to carry out the functions attributed to the various modules or applications described herein. In an embodiment, the processor 130 may comprise a single processor or a multi-processor system.

In an embodiment, the storage medium 150 comprises a user interface module 152, a communication module 154, user applications, and user management module 158. In alternative embodiments, the storage medium 150 may comprise different or additional components.

The user interface module 152 comprises visual and/or audio elements and controls for enabling user interaction with the communication system 120. For example, the user interface module 152 may receive inputs from the user input device 122 to enable the user to select various functions of the communication system 120. In an example embodiment, the user interface module 152 includes a calling interface to enable the communication system 120 to make or receive voice and/or video calls over the network 110. To make a call, the user interface module 152 may provide controls to enable a user to select one or more contacts for calling, to initiate the call, to control various functions during the call, and to end the call. To receive a call, the user interface module 152 may provide controls to enable a user to accept an incoming call, to control various functions during the call, and to end the call. For video calls, the user interface module 152 may include a video call interface that displays remote video from a client device 115 together with various control elements such as volume control, an end call control, or various controls relating to how the received video is displayed or the received audio is outputted.

The user interface module 152 may furthermore enable a user to access user applications 156 or to control various settings of the communication system 120. In an embodiment, the user interface module 152 may enable customization of the user interface according to user preferences. Here, the user interface module 152 may store different preferences for different users of the communication system 120 and may adjust settings depending on the current user.

The communication module 154 facilitates communications of the communication system 120 with client devices 115 for voice and/or video calls. For example, the communication module 154 may maintain a directory of contacts and facilitate connections to those contacts in response to commands from the user interface module 152 to initiate a call. Furthermore, the communication module 154 may receive indications of incoming calls and interact with the user interface module 152 to facilitate reception of the incoming call. The communication module 154 may furthermore process incoming and outgoing voice and/or video signals during calls to maintain a robust connection and to facilitate various in-call functions.

The user applications 156 comprise one or more applications that may be accessible by a user via the user interface module 152 to facilitate various functions of the communication system 120. For example, the user applications 156 may include a web browser for browsing web pages on the Internet, a picture viewer for viewing images, a media playback system for playing video or audio files, an intelligent virtual assistant for performing various tasks or services in response to user requests, or other applications for performing various functions. In an embodiment, the user applications 156 includes a social networking application that enables integration of the communication system 120 with a user's social networking account. Here, for example, the communication system 120 may obtain various information from the user's social networking account to facilitate a more personalized user experience. Furthermore, the communication system 120 can enable the user to directly interact with the social network by viewing or creating posts, accessing feeds, interacting with friends, etc. Additionally, based on the user preferences, the social networking application may facilitate retrieval of various alerts or notifications that may be of interest to the user relating to activity on the social network. In an embodiment, users may add or remove user applications 156 to customize operation of the communication system 120.

The user management module 158 manages owner profiles and customizes operation of the communication system 120 based on identity predictions for individuals interacting with the communication system 120. Particularly, the user management module 158 stores data in owner profiles associated with users of the communication system 120 and provides owner profile data to other components of the communication system 120. For example, the user management module 158 may create, process, and/or provide owner profile data based on an interaction with the user interface module 152, communication module 154, or any of the user applications 156. Owner profile data may include personal information for a user of the communication system 120 (e.g., name, age, gender, etc.), biometric information for a user (e.g., images and/or scans of the face of the user, recordings of the voice of the user, fingerprint scans for the user, etc.), and activity information for the user (e.g., previous interactions of the user with the communication system 120). The communication system 120 may prompt the user to provide biometric data of various types for capture, such as when an owner profile is first created. A user of the communication system 120 may optionally opt out of providing this information. Additionally, the user management module 158 receives recognition information associated with individuals within a recognition range of the communication system 120 and calculates confidence levels for the predicted identities of the detected individual based on the owner profile data. The confidence levels may be scores indicating a likelihood that a detected individual has a particular identity (e.g., 70% confidence the individual is person X). The user management module 158 may determine the confidence levels based on received biometric information for a detected individual (e.g., facial imagery, voice audio, fingerprint, etc.) and/or contextual information relating to the communication system 120 and comparing it to stored biometric data associated with the different owner profiles. Based on one of more determined confidence levels, the user management module 158 may determine whether authentication criteria associated with different features of the communication system 120 are satisfied and may confirm or deny access to the feature. In an alternative embodiment, all or a portion of the functions of the user management module 158 may execute on the communication server 105 instead of on the communication system 120.

In some embodiments, the user management module 158 associates authentication criteria with actions of the communication system 120 which include a confidence threshold. The confidence thresholds may be associated with varying degrees of access to features of the communication system 120 depending in part on one or more confidence levels. For example, the user management module 158 may associate a low, medium, and high confidence threshold (e.g., above 50%, 75%, and 90% confidence, respectively) with actions of the communication system 120. If the low confidence threshold is met for any one of the owner profiles, the communication system 120 may grant access to a limited set of actions associated with generic features, such as accessing a weather forecast, the current time, playing a song, or any other generic feature which is not specific to an owner profile. If the medium confidence threshold is met for one of the owner profiles, the communication system 120 may grant further access to actions associated with features that can be personalized to the owner profile, such as displaying a calendar, displaying a home screen, customizing a user interface based on settings associated with the owner profile, allowing an incoming call, or other features relevant to user customization. If the high confidence threshold is met for one of the owner profiles, the communication system 120 may grant still further access to action associated with features that process sensitive or private data (i.e., restricted features), such as initiating communication (e.g., messages, video calls, voice calls, etc.), stored login credentials, owner profile data, or uploading media content to the communication system 120 or third-party systems, etc. In other examples, some features (e.g., basic features) may be accessible without the requesting user meeting any confidence threshold (e.g., even the low confidence threshold) for one of the owner profiles (i.e., non-restricted features). For example, the device may be configured such that any individual (even non-owners) can wake the device up from a low power state and access the home screen. In other embodiments, features may be made accessible or inaccessible based on confidence levels associated with multiple detected individuals. For example, if the communication system 120 detects with a high level of confidence that one of the owners is present but also detects that an unknown individual is present (the confidence level associated with all known owners is low), the communication system 120 may prevent the owner from accessing highly sensitive information without further confirmation since it may become visible to the unknown individual. In various embodiments the user management module 158 may include additional or fewer confidence thresholds to those described above.

The communication system 120 maintains and enforces one or more privacy settings for users of the communication system 120 (e.g., users associated with an owner profile or other individuals interacting with the communication system 120). A privacy setting of a user determines how particular information associated with the user can be shared, and may be stored in association with information identifying the user (e.g., in an owner profile associated with the user). In some embodiments, the communication system 120 retrieves privacy settings for one or more owner profiles maintained by the communication system 120. In one embodiment, a privacy setting specifies particular information associated with a user and identifies other entities with whom the specified information may be shared. Examples of entities with which information can be shared may include other users, applications, third party systems, or any entity that can potentially access the information. Examples of information that can be shared by a user include image data including the user, audio data including audio captured from the user, video data including the user or the person, other biometric data including biometric information describing the user, and the like.

For example, in particular embodiments, privacy settings may allow a user to specify (e.g., by opting out, by not opting in) whether the communication system 120 may receive, collect, log, or store particular objects or information associated with the user for any purpose. In particular embodiments, privacy settings may allow the user to specify whether particular video capture devices (e.g., the camera sub-system 126), audio capture devices (e.g., the microphone sub-system 124), applications (e.g., the user applications 156) or processes may access, store, or use particular objects or information associated with the user. The privacy settings may allow the user to opt in or opt out of having objects or information accessed, stored, or used by specific devices, applications or processes. The communication system 120 may access such information in order to provide a particular function or service to the user, without the communication system 120 having access to that information for any other purposes. Before accessing, storing, or using such objects or information, the communication system 120 may prompt the user to provide privacy settings specifying which applications or processes, if any, may access, store, or use the object or information prior to allowing any such action. As an example and not by way of limitation, a first user may transmit a message to a second user via an application related to the communication system 120 (e.g., a messaging app), and may specify privacy settings that such messages should not be stored by the communication system 120.

As described above with reference to the user input device 122 and user management module 158, the communication system 120 can collect or otherwise receive biometric data from a user to for use in user-authentication or experience-personalization purposes (e.g., determining confidence levels of an identity for an individual). A user may opt to make use of these functionalities to enhance their experience using a client device 115 and the communication system 120. As an example and not by way of limitation, a user may voluntarily provide personal or biometric information to the communication system 120. The user's privacy settings may specify that such information may be used only for particular processes, such as authentication, and further specify that such information may not be shared with any third-party or used for other processes or applications associated with the communication system 120. Any of such restrictions on captured biometric or other personal data may also be applied to the client devices 115 or communication server 105.

Users may authorize the capture of data, identification of individuals, or sharing and cross-application use of user-related data by the communication system 120 in one or more ways. For example, users may pre-select various privacy settings before the users use the features of the client devices 115 or interact with the communication system 120. In another case, a selection dialogue may be prompted when users first interact with the communication system 120 or use a feature of the client devices 115 or the communication system 120 or when users have not carried out the action or used the feature for a predetermined period of time. In yet another example, the client devices 115 and the communication system 120 may also provide notifications to the users when certain features that require user data begin to operate or are disabled due to users' selections to allow users to make further selections through the notifications. Other suitable ways for users to make authorizations are also possible.

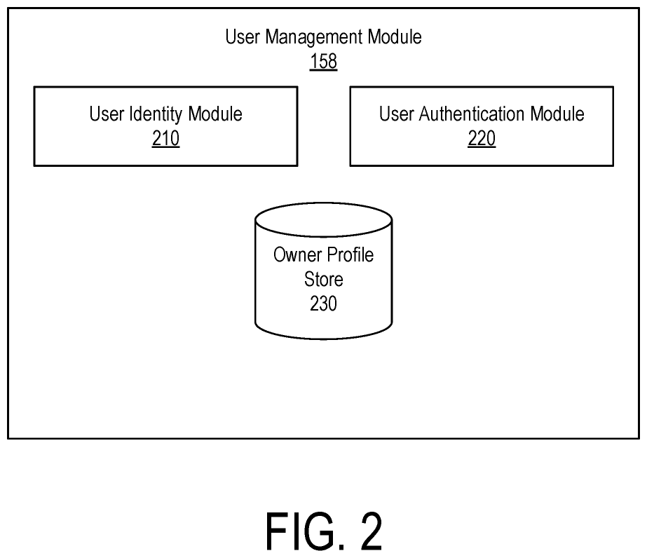

FIG. 2 illustrates an example embodiment of a user management module 158. In an embodiment, the user management module 158 comprises a user identity module 210, a user authentication module 220, and an owner profile store 230. In alternative embodiments, the user management module 158 may include different or additional components.

The user identity module 210 predicts an identity of one or more individuals within a recognition range of the communication system 120 using one or more confidence levels. A confidence level for an identity of a detected individual may be determined by the user identity module 210 based on received recognition information describing one or more individuals. In particular, a confidence level indicating a detected individual is a user associated with a particular owner profile may be determined based on a comparison of received recognition for the detected individual to corresponding owner profile data stored by the owner profile. The user identity module 210 may determine a confidence level for each of the owner profiles stored in the owner profile store 230. A user of the communication system 120 may optionally disable and/or opt out of any of the processes performed by the user identity module 210 to predict an identity of one or more individuals as described herein.

In some embodiments, the user identity module 210 receives recognition information including biometric data describing one or more characteristics of an individual within a recognition range of the computing device. In this case, the user identity module 210 may use the biometric data to determine one or more confidence levels for respective predicted identities of an individual. The biometric data may correspond to various biometric indicators, such as physiological characteristics (e.g., face, fingerprint, palm print, iris, retina, scent, etc.) or behavioral characteristics (e.g., gait, voice, etc.). The biometric information may include confidence levels of a predicted identity of the individual for respective biometric indicators (i.e., biometric confidence levels) determined by other components of the communication system 120 and/or third party systems. The communication system 120 may determine a biometric confidence level the individual is a user associated with a particular owner profile by comparing received biometric data to corresponding biometric data stored in the owner profile. For example, one or more components of the communication system 120 may capture an image of a face of an individual (e.g., using the camera sub-system 126) and use a facial recognition system to detect the face in the image, and may further determine a biometric confidence level for a respective identity prediction based on the face. Similarly, the communication system 120 may use respective processes to determine biometric confidence levels of identities of an individual based on other biometric indicators (e.g., voice recognition, finger print recognition, iris and/or retina recognition, etc.). The user identity module 210 may combine one or more biometric confidence levels included in the received biometric information in order to determine one or more confidence levels for respective identities of the individual. For example, the user identity module 210 may calculate confidence levels as a function of the biometric confidence levels, such as a linear combination of biometric confidence levels. In the same or different embodiments, the user identity module 210 may process biometric data describing one or more biometric indicators directly (e.g., perform facial recognition on images, perform voice recognition on audio, etc.) in order to determine one or more confidence levels for respective predicted identities of an individual.

The confidence levels determined by the user identity module 210 may vary depending on the biometric data available during a particular time interval. In particular, the user identity module 210 may determine higher confidence levels when more types of biometric data are available and when the biometric data which is available is of higher quality (e.g., more data or less noise). The biometric data available to the user identity module 210 may vary depending on individual behavior and/or a configuration of the communication system 120. For example, the types of biometric data received by the user identity module 210 may vary depending on whether the user is speaking (i.e., making voice data available) or standing in front of a camera (i.e., making facial data available). Additionally, the user identity module 210 may receive less or noisy biometric data depending on behavior of the individual. For example, the user identity module 210 may receive less or noisy biometric data for facial recognition if an individual is facing away from a camera of the camera sub-system 126, moving quickly in front of a camera, or if the face of the individual is not sufficiently illuminated (e.g., lights around the communication system 120 are off). Similarly, the user identity module 210 may receive less or noisy biometric data for voice recognition if the individual is speaking quietly, multiple individuals are speaking at once, or the communication system is receiving multiple other audio signals (e.g., music or other background noise). Furthermore, one or more components of the communication system 120 which are used to collect or process biometric data may be performing other tasks or disabled during a particular time interval. For example, an individual may be using a camera of the camera sub-system 126 for a video call. As such, the user identity module 210 may determine one or more confidence levels for respective identities of an individual using the biometric data available and/or applicable during a particular time interval, and may update the one or more confidences level as the available biometric data and/or configuration of the communication system 120 changes.

The communication system 120 may determine biometric confidence levels using any technique for identifying an individual based on data relating to a biometric indicator. For example, components of the communication system 120 may use image processing techniques to determine biometric confidence levels, such as computer vision models trained for face recognition, gait recognition, iris recognition, retina recognition, finger print recognition, etc. Similarly, the communication system may use audio processing techniques to determine biometric confidence levels, such as natural language processing models trained for voice recognition. The communication system 120 may train one or more models for determining biometric confidence levels indicating a likelihood a detected individual is a user associated with an owner profile using owner profile data stored in the owner profiles. For example, the communication system may train a model for determining a predicted biometric confidence level corresponding to a particular biometric indicator by labeling biometric data stored in the owner profiles as belonging to the user associated with the respective owner profile.

In some embodiments, the user identity module 210 or another component of the communication system 120 may obtain biometric data from an interaction by an individual with the communication system 120. For example, an individual may issue a voice command, make a facial expression, make a hand gesture, interact with a remote control associated with the communication system 120, or perform any other interaction which provides a biometric signal to a biometric sensor of the communication system 120. In this case, the user identity module 210 may use the biometric data obtained from the interaction to determine one or more confidence levels for respective identities of the individual.

In some embodiments, the user identity module 210 receives recognition information including contextual information describing activity of one or more individuals. In this case, the user identity module 210 may use the contextual information to determine one or more confidence levels for respective predicted identities of an individual. The user identity module 210 may determine a confidence level the individual is a user associated with a particular owner profile by comparing an interaction by the individual to activity data stored in the owner profile. For example, the user identity module 210 may determine a higher a confidence level associated with a particular owner profile if the interaction has been performed by a user associated with the owner profile (e.g., launching a particular application or calling a particular contact), or a lower confidence level if the user has not performed the interaction. As another example, the contextual information may include information regarding previously detected individuals (e.g., within the last five minutes), such as recent confidence levels for predicted identities or tracked movement of an individual (e.g., provided by the camera sub-system 126). As still another example, the user identity module 210 may receive one or more locations of client devices (e.g., the client devices 115), such as client devices associated with owner profiles in the owner profile store 230. In this case, the user identity module 210 may determine a higher confidence level for an identity associated with a particular owner profile if a client device associated with the owner profile is detected within a threshold distance of the communication system 120 (e.g., 20 meters). Similarly, the user identity module 210 may determine a lower confidence level for an identity associated with a particular owner profile if the associated client device is detected beyond a threshold distance (i.e., the client device is not in the same general location as the communication system 120).

The user identity module 210 may use the contextual information in combination with additional recognition information, such as biometric data, to determine one or more confidence levels for respective identities of an individual. For example, if the user identity module 210 determines a low confidence level for an individual when there is limited or noisy biometric data, but had previously determined a high confidence level (e.g., 95%) within a recent time period, such as the last five seconds, the user identity module 210 may raise the otherwise low confidence level based on an inferred likelihood that it is the same individual for both confidence levels. In particular, the user identity module 210 may weight a confidence level for a predicted identity of an individual determined using biometric data based on one or more values included in the contextual information.

As described above for biometric data, the contextual information used by the user identity module 210 during a particular time interval may vary depending on individual behavior and/or a configuration of the communication system 120. For example, a threshold amount of time may have elapsed since an individual interacted with the communication system 120 (e.g., an hour), in which case the user identity module 210 may not consider previously detected individuals in determining one or more confidence levels. Similarly, the user identity module 210 may consider more, less, and/or different contextual information depending on the state of the communication system 120. For example, the communication system 120 may consider less contextual information when the communication system 120 is interacted with after being in a rest state (e.g., sleep mode) than after performing a task for a user associated with an owner profile (e.g., displaying an owner profile calendar). As another example, the user identity module 210 may not have access to updated location information associated with client devices during a particular time interval (e.g., location sharing is disabled, or the client device is not connected to a network). As such, the user identity module 210 may determine one or more confidence levels for respective identities of an individual using the contextual information available and/or applicable during a particular time interval, and may update the one or more confidences level as the context information or the configuration of the communication system 120 changes.

The user identity module 210 may continually predict identities for an individual (e.g., update one or more confidence levels every second). Alternatively, or additionally, the user identity module 210 may predict the identity of an individual in response to an event, such an individual being detected within a recognition range of the communication system 120, an individual interacting with the communication system 120, or receiving new or updated recognition information for an individual. The user identity module 210 may provide multiple confidence levels for respective identities of an individual to other components of the communication system 120. Alternatively, the user identity module 210 may select one or more particular confidence level to provide to other components, such as the highest confidence level.

In some embodiments, the user identity module 210 stores one or more confidence levels for predicted identities of individuals. The user identity module 210 may additionally, or alternatively, store recognition information used to determine confidence levels. The user identity module 210 may provide stored confidence levels and/or recognition information to other components of the communication system 120. For example, the user identity module 210 may provide stored confidence levels and/or recognition information to the user authentication module 220 to be used for determining whether authentication criteria for actions associated with features of the communication system 120 are satisfied, as described below.

The user authentication module 220 determines whether authentication criteria are satisfied for performing actions associated with features of the communication system 120. The user authentication module 220 may include a mapping (e.g., a table, hash map, or other data structure) from actions and/or features to authentication criteria for those actions and/or features. In particular, the authentication criteria for a particular action may include a confidence threshold at which the actions and/or feature become available, and the authentication criteria may be satisfied if a confidence level for the individual exceeds the confidence threshold. The authentication criteria for an action and/or feature may additionally or alternatively be satisfied based on recognition information (e.g., contextual information). The user authentication module 220 may receive a request from another component of the communication system 120 (e.g., user applications 156) regarding whether the component is authorized to perform an action. In this case, the user authentication module 220 may use the mapping and to identify the authentication criteria for the action and determine whether the authentication criteria are satisfied. If there are multiple confidence levels received for an individual, the user authentication module 220 may select a particular confidence level to determine whether authentication criteria are satisfied 1 (e.g., the highest confidence level).

The user authentication module 220 may receive a request regarding whether an action is available from a component of the communication system 120 in response to activity by an individual. For example, an individual may move in front of a camera component of the communication system 120, speak a voice command, interact with a remote control associated with the communication system 120, or otherwise interact with the communication system 120. The user authentication module 220 may also receive a request from a component based on processes of the communication system 120, such as displaying an upcoming calendar event based on the current time. As one or more confidence levels for an individual may change dynamically over time, components of the communication system 120 may verify whether an action is available before executing every action. Alternatively, or additionally, components of the communication system 120 may periodically verify whether one or more actions are available, such as every five minutes, or when an individual interacts with the communication system 120 after a period of no interactions.

In some embodiments, the user authentication module 220 may set an overall authentication level for the communication system 120 by determining whether overall authentication criteria are satisfied. For example, a set of overall authentication levels may each have their own respective authentication criteria, such as a confidence threshold and/or requirement for a predicted identity (e.g., the identity must be associated with an owner profile). The user authentication module 220 may provide the current overall authentication level to other components of the communication system 120.

In some embodiments, the user authentication module 220 considers multiple individuals detected by the communication system 120 to determine an authentication level. For example, the user authentication module 220 may receive confidence levels corresponding to multiple individuals when multiple individuals are detected by the communication system 120. In this case, the authentication criteria for a given action may not be satisfied if more than one individual is within a recognition range of the communication system 120. In this case, the user authentication module 220 may protect sensitive data by providing access to generic features (i.e., which are not specific to a particular owner profile) in order to accommodate multiple individuals interacting with the communication system 120 within a short time period.

In some embodiments, the user authentication module 220 determines whether actions and/or features are available based in part on a geographic location of the communication system 120. In this case, the authentication criteria for an action may specify one or more locations at which the action is and/or is not available (i.e., location restrictions). For example, certain actions may not be available in certain geographic regions, such as countries or cities, for reasons such as local laws, regulations, or customs. As another example, certain actions may not be available based on characteristics of a venue associated with the location of the communication system 120, such as restricting certain actions in public venues (e.g., a meeting room) that are otherwise available in private venues (e.g., a residence). venue.

In some embodiments, the user authentication module 220 stores information describing previous confidence levels for detected individuals. For example, the user authentication module 220 may store confidence levels determined within a time range, such as the last hour. Additionally, or alternatively, the user authentication module 220 may store previous interactions by individuals with the communication system 120 and/or actions performed by the communication system 120. Similar to the previous example, the user authentication module 220 may store interactions and/or actions from a time range.

In some embodiments, the user authentication module 220 associates authentication criteria with actions associated with features of the communication system 120 and/or authentication levels. The communication system 120 may allow individuals to adjust authentication criteria in order to customize the availability of features. For example, an individual may prefer to be able to send private messages through the communication system 120 even if a confidence level for a predicted identity of the individual is relatively low. As such, the individual may adjust settings of the communication system 120 such that the user authentication module 220 associates authentication criteria with actions relating to private messaging which include a low confidence threshold. Furthermore, the user authentication module 220 may allow adjustment of authentication criteria for actions of the communication system 120 and/or authentication levels for all users of the communication system 120 (i.e., universal settings) and/or adjustments for individual owner profiles.

### Action Authentication using Confidence Levels

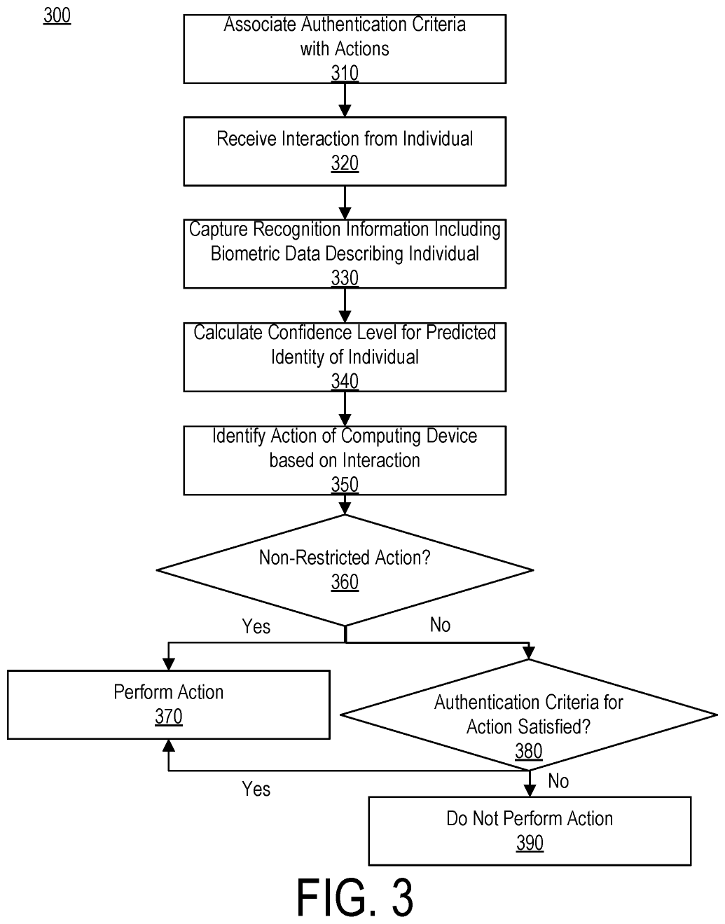

FIG. 3 is a flow diagram of a method 300 for performing an action based on a confidence level associated with a predicted identity of an individual, in accordance with an embodiment. The method 300 shown in FIG. 3 may be performed by components of a communication system (e.g., the communication system 120). Other entities may perform some or all of the steps in FIG. 3 in other embodiments. Embodiments may also include different and/or additional steps or perform the steps in different orders.

The communication system 120 associates 310 different authentication criteria with different actions of the communication system 120. In particular, the authentication criteria include respective confidence thresholds that when exceeded, causes associated actions to become available to an individual requesting the action. For example, the user authentication module 220 may store authentication criteria for actions or groups of actions associated with features and/or components of the communication system 120. As another example, the user authentication module 220 may store authentication criteria associated with authentication levels, and components of the communication system 120 may associate actions or groups of actions with authentications levels.

The communication system 120 receives 320 an interaction from an individual with the communication system 120. For example, an individual may appear in front of a camera of the communication system 120, speak a voice command, select a button on a user interface of the communication system 120, or otherwise interact with the communication system 120.

The communication system 120 captures 330 recognition information including biometric data describing the individual who interacted with the communication system 120. For example, the communication system 120 may capture facial image data (e.g., using the camera sub-system 126), voice audio date (e.g., using the microphone sub-system 124), finger print data (e.g., using a remote control), additional biometric data, or any combination thereof. The recognition information may include contextual information, such as information regarding recent interactions with the communication system 120 or one or more locations of client devices associated with the communication system 120.

Using the recognition information, the communication system 120 calculates 340 a confidence level for a predicted identity of the individual by comparing the recognition information to owner profile data corresponding to one or more owner profiles associated with the communication system 120. For example, the user identity module 210 may calculate one or more confidence levels for one or more respective predicted identities for the individual using the recognition information.

The communication system 120 identifies 350 an action corresponding to the interaction by the individual. For example, the interaction may be an attempt to initiate a video call, in which case the communication system 120 may identify an action related to initiating the video call by the communication module 154.

After identifying the action, the communication system 120 determines 360 whether the action is a non-restricted action. Responsive to determining that the action is non-restricted, the communication system 120 performs 370 the action. If the communication system 120 instead determines that the action is restricted, the communication system 120 determines 380 whether the authentication criteria associated with the action are satisfied based on the confidence level. In particular, the communication system 120 may determine that the authentication criteria for the action are satisfied based in part on the confidence level exceeding the confidence threshold included in the authentication criteria. Responsive to determining that the authentication criteria associated with the action are satisfied, the communication system 120 performs 370 the action. If the communication system 120 instead determines that the authentication criteria associated with the action are not satisfied, the communication system 120 does not perform 390 the action.

### Conclusion

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
associating authentication criteria with respective actions of a computing device, the authentication criteria for each respective action including a confidence threshold;
receiving, by the computing device, an interaction from an individual within a recognition range of the computing device;
capturing, by the computing device, recognition information including biometric data describing the individual;
calculating a confidence level associated with a predicted identity of the individual based at least in part on the recognition information;
identifying an action of the computing device based on the interaction;
determining the authentication criteria associated with the action are satisfied based at least in part on the confidence level exceeding the confidence threshold of the authentication criteria; and
responsive to determining the authentication criteria associated with the action are satisfied, performing the action.

2. The method of claim 1, wherein performing the action comprises:
accessing a restricted feature of the computing device, the restricted feature only available when the authentication criteria are satisfied.

3. The method of claim 1, wherein calculating the confidence level for the predicted identity of the individual comprises:
associating a plurality of owner profiles with the computing device;
calculating one or more confidence levels for one or more respective owner profiles from the plurality of owner profiles, the one or more confidence levels indicating a likelihood the individual is a user associated with a respective owner profile;
comparing the one or more confidence levels; and
selecting the confidence level for the predicted identity from the one or more confidence levels based on the comparison.

4. The method of claim 3, wherein performing the action comprises:
displaying information relevant to the respective owner profile for the selected confidence level.

5. The method of claim 3, wherein performing the action comprises:
configuring one or more settings of the computing device based on one or more preferences associated with the respective owner profile for the selected confidence level.

6. The method of claim 3, wherein performing the action comprises:
initiating a communication with a contact of the respective owner profile for the selected confidence level.

7. The method of claim 1, further comprising:
receiving, by the computing device, a second interaction from a second individual within the recognition range of the computing device;
identifying a second action of the computing device based on the second interaction;
responsive to determining the second action is a non-restricted action, performing the second action.

8. The method of claim 1, wherein the biometric data is selected from the group comprising:
images of a body of the individual, images of an eye of the individual, audio of a voice of the individual, and finger prints of the individual.

9. The method of claim 1, wherein calculating the confidence level further comprises:
capturing the recognition information based at least in part on the interaction.

10. The method of claim 1, wherein the recognition information further includes contextual information describing activity by one or more individuals.

11. The method of claim 10, wherein the activity included in the contextual information is selected from the group comprising: previous interactions by the one or more individuals with the computing device, previously determined confidence levels for identities of the one or more individuals, and a position of a client device corresponding to an owner profile associated with the computing device.

12. The method of claim 1, wherein calculating the confidence level comprises:
tracking movement of the individual within the recognition range; and
determining the confidence level based at least in part on the tracked movement.

13. The method of claim 1, wherein determining the authentication criteria are satisfied further comprises:
capturing additional recognition information describing one or more additional individuals within the recognition range;
calculating one or more additional confidence levels associated with respective predicted identities of the one or more additional individuals based at least in part on the additional recognition information; and
determining the authentication criterion is satisfied based in part on the one or more additional confidence levels.

14. The method of claim 1, wherein the authentication criteria include one or more location restrictions, and wherein determining the authentication criteria are satisfied further comprises:
identifying a geographic location of the computing device;
comparing the geographic location to the one or more location restrictions; and
determining, based on the comparison, the authentication criteria are satisfied based in part on the geographic location not being specified by the location restrictions.

15. A non-transitory computer-readable storage medium, storing one or more programs configured for execution by one or more processors of a computing device, the one or more programs including instructions for:
associating authentication criteria with respective actions of the computing device, the authentication criteria for each respective action including a confidence threshold;
receiving, by the computing device, an interaction from an individual within a recognition range of the computing device;
capturing, by the computing device, recognition information including biometric data describing the individual;
calculating a confidence level associated with a predicted identity of the individual based at least in part on the recognition information;
identifying an action of the computing device based on the interaction;
determining the authentication criteria associated with the action are satisfied based at least in part on the confidence level exceeding the confidence threshold of the authentication criteria; and
responsive to determining the authentication criteria associated with the action are satisfied, performing the action.

16. The computer-readable storage medium of claim 15, wherein performing the action comprises:
accessing a restricted feature of the computing device, the restricted feature only available when the authentication criteria are satisfied.

17. The computer-readable storage medium of claim 15, wherein calculating the confidence level for the predicted identity of the individual comprises:
associating a plurality of owner profiles with the computing device;
calculating one or more confidence levels for one or more respective owner profiles from the plurality of owner profiles, the one or more confidence levels indicating a likelihood the individual is a user associated with a respective owner profile;
comparing the one or more confidence levels; and
selecting the confidence level for the predicted identity from the one or more confidence levels based on the comparison.

18. The computer-readable storage medium of claim 17, wherein performing the action comprises:
displaying information relevant to the respective owner profile for the selected confidence level.

19. The computer-readable storage medium of claim 17, wherein performing the action comprises:
configuring one or more settings of the computing device based on one or more preferences associated with the respective owner profile for the selected confidence level.

20. The computer-readable storage medium of claim 17, wherein performing the action comprises:
initiating a communication with a contact of the respective owner profile for the selected confidence level.
